(19) United States
(12) Patent Application Publication
(10) Pub. No.: US 2018/0193797 A1
(43) Pub. Date: Jul. 12, 2018

(54) THREE WAY CATALYST HAVING AN NH3-SCR ACTIVITY, AN AMMONIA OXIDATION ACTIVITY AND AN ADSORPTION CAPACITY FOR VOLATILE VANADIUM AND TUNGSTEN COMPOUNDS

(71) Applicant: HALDOR TOPSØE A/S, Kgs. Lyngby (DK)

(72) Inventors: Keld JOHANSEN, Frederikssund (DK); Ton V.W. JANSSENS, Bagsvaerd (DK)

(73) Assignee: UMICORE AG & CO. KG, Hanau-Wolfgang (DE)

(21) Appl. No.: 15/741,638

(22) PCT Filed: Jul. 6, 2016
(86) PCT No.: PCT/EP2016/065952

§ 371 Date: Jan. 3, 2018

(30) Foreign Application Priority Data
Jul. 9, 2015 (DK) PA 2015 00404

(51) Int. Cl. B01D 53/94; B01J 35/04; B01J 37/02; B01J 35/02; B01J 35/10; B01J 23/42; B01J 23/30; B01J 23/652; F01N 3/10; F01N 3/20; F01N 3/28

(52) U.S. Cl. CPC B01D 53/945; F01N 2610/02; B01D 53/9436; B01J 35/04; B01J 37/0201; B01J 37/0244; B01J 35/023; B01J 35/10; B01J 23/42; B01J 23/30; B01J 23/6527; F01N 3/101; F01N 3/2066; F01N 3/2825; B01D 2255/1021; B01D 2255/20707; B01D 2255/20723; B01D 2255/20776; B01D 2255/30; B01D 2255/9022; B01D 2255/9202; B01D 2255/9205; F01N 2370/04; F01N 2510/0684; B01D 53/9418

(57) ABSTRACT

Three way catalyst having an NH₃-SCR activity, an ammonia oxidation activity and an adsorption capacity for volatile vanadium and tungsten compounds volatilized off an upstream SCR active catalyst.

The present invention relates to a three way catalyst having an NH₃-SCR activity, an ammonia oxidation activity and an adsorption capacity for volatile vanadium and tungsten compounds

The exhaust system of modern vehicles with lean burning engines is typically equipped with an oxidation catalyst, a particulate filter and a catalyst for the selective reduction of NOx (SCR) in presence of a reduction agent.

Oxidation catalysts being active in the oxidation of volatile organic compounds and carbon monoxide and SCR catalysts are known in the art and disclosed in numerous publications.

Typically employed particulate filters (DPF) in diesel exhaust gas cleaning systems, are wall flow filters with a plurality if inlet and outlet channels. The inlet channels are closed at their outlet side and the outlet channels are closed at their inlet side, so that the gas flowing into the filter is forced through porous walls defining the channels, whereby particulate matter is filtered off the gas.

To meet future emission regulations for diesel passenger cars and trucks requires usage of both diesel particulate filter (DPF) technology and NOx reduction catalyst. Due to its potential for fuel optimization and high efficiency in NOx removal, selective catalytic reduction using ammonia as a reductant (NH₃-SCR) is presently the preferred technology for NOx reduction.

The SCR catalyst can be arranged as a separate unit up-stream and/or downstream the DPF. It has also been suggested in the art providing the DPF with an SCR catalyst to obtain more compact cleaning systems.

Catalysts for use in ammonia SCR are well known in the art. Of those, catalysts based on V₂O₅ and WO₃ supported on a TiO₂ carrier provide a fundamental solution to effectively reduce NOx emissions from Diesel fueled vehicles by means of the Selective Catalytic Reduction (SCR) with ammonia. Compared to alternative strategies for NOx emission control like exhaust gas recirculation (EGR) and zeolite-based catalysts, a great advantage of vanadium-based SCR catalysts is its fuel efficiency, robustness to sulfur and/or price.

When operating a cleaning system with a DPF, particulate matter trapped in the filter must from time to time or continuously be removed in order to avoid pressure drop over the filter. An increased pressure drop costs fuel penalty. Therefore, particulate matter accumulated on the filter walls at inlet side of the filter must be removed either by active regeneration, wherein particulate matter is catalytically burned off in contact with an oxidation catalyst supported on the filter walls in combination with oxygen in exhaust gas at increased exhaust gas temperatures or by non-catalytic passive regeneration.

In the passive soot regeneration the DPF is regenerated at temperatures below 550° C. with NO₂ that is generated over the upstream DOC by oxidation of NO. Regeneration with oxygen in exhaust gas should be avoided in order to control the temperature below 550° C. If the filter uncontrolled regenerates with oxygen the temperature can rise above 550° C.

Despite being effective SCR catalysts, vanadium oxide based catalysts contain V₂O₅ as an essential component, which is toxic. Reports in the literature suggest that bulk V₂O₅ has a significant vapor pressure at temperatures relevant to the catalyst operation, and both V and W compounds react with water to form species with increased vapor pressure.

Measurable amounts of vanadium are first released at temperatures of above 600° C., which is around the highest applicable working temperature of these systems.

Consequently, there is a risk of V and W volatile compounds can vaporize from the V₂O₅/WO₃/TiO₂ SCR catalysts in particular when integrated in the DPF. The temperature in V-SCR catalysed DPF has the highest probability of being exposed to temperatures exceeding 600° C., but in severe events the temperature in the V-SCR can also at the same time increase above 600° C. and trigger evaporation of these compounds.

Beside the risk of emission of vanadium and tungsten compounds into the atmosphere, ammonia slip from the SCR reaction has also to be considered. To obtain a maximum NOx conversion, ammonia is typically added to the exhaust gas in over stoichiometric amounts and unreacted ammonia is emitted to the atmosphere.

The present invention seeks to solve the above problems caused by employing vanadium and tungsten oxides as effective ammonia SCR catalyst and over stoichiometric amounts of ammonia reductant in the SCR reaction in a system for the removal of particulate matter and noxious compounds including nitrogen oxides from an engine exhaust gas by combining a vanadium and tungsten adsorbent with an ammonia oxidation catalyst.

Thus, the present invention is in its broadest aspect a Three way catalyst having an NH₃-SCR activity, an ammonia oxidation activity and an adsorption capacity for volatile vanadium and tungsten compounds volatilized off an upstream the SCR active catalyst, the three way catalyst comprising high surface compounds selected from high surface metal oxides, zeolites, silica, non-zeolite silica alumina, and mixtures thereof.

Several oxides have the property to adsorb evaporated compounds of vanadium and tungsten. Oxides of vanadium, tungsten and titanium admixed with at least one of a high surface ceria, alumina, silica, zirconia, non-zeolite silica alumina and zeolites, have shown as useful V and W compounds adsorbent and are at the same time active in the SCR reaction. These adsorbents are preferably combined with an ammonia slip catalyst (ASC).

Typical ASC formulations consist of an ammonia oxidation function based on platinum, optionally combined with palladium, on an alumina or titania carrier and an SCR active catalyst. In preferred formulations for use in the invention the V,W adsorbent is applied together with an SCR catalyst as a top layer on a bottom layer with the ammonia oxidation catalyst. Both layers can contain binding phases of oxide ceramics as alumina, titania, silica-alumina that have V,W adsorbing capacities.

In a specific embodiment of the invention, the three way catalyst comprises a bottom layer comprising platinum, alumina and/or titania and optionally palladium, coated on a substrate or partly or entirely forming the substrate, a top layer comprising oxides of vanadium, tungsten and titanium admixed with at least one of a high surface ceria, alumina, silica, zirconia, non-zeolite silica alumina and zeolite.

As the three way catalyst will be typically arranged at the coldest position in an exhaust system any potentially evaporated V and W compounds will be trapped on the three way catalyst during the life time of the exhaust system on a vehicle.

Good vanadium and tungsten adsorption efficiencies are achieved with a relatively thick top layer in the three way catalyst.

Thus, in preferred embodiments the top layer has layer thickness of between 40 μm and 250 μm.

In further a preferred embodiment the bottom layer has a layer thickness of between 5 μm and 80 μm. When the bottom layer itself forms partly or entirely the substrate the layer thickness is up to 450 μm.

In order to assure sufficient permeation of ammonia from the top layer to the bottom layer, the top layer must be relatively porous.

Thus, in further a preferred embodiment the top layer has a porosity of between 20% and 80%.

Preferably the three way catalyst is coated on a substrate with a flow through monolith shape.

When coated on a substrate with a flow through monolith shape, the amount of the top layer in the three way catalyst is between 50 and 500 g per liter of the flow through monolith.

The amount of the bottom layer in the three way catalyst is preferably between 5 and 255 g per liter of the flow through monolith, the exactly amount depends on whether the bottom layer is coated on surface of the monolith substrate or partly or entirely forms the monolith substrate.

Good ammonia oxidation activities of the three way catalyst are obtained, when the bottom layer of the three way catalyst contains 0.0018 g-0.35 g platinum and/or palladium per liter of the substrate.

The top layer of the three way catalyst comprises preferably per liter of the flow through monolith 1.0 g-20 g vanadium pentoxide, 3 g-40 g tungsten oxide, 40 g-460 g titania, and 0 g-86 g silica, 0 g-86 g ceria, 0 g-86 g alumina, 0 g-86 g non-zeolite silica alumina and 0 g-86 g of a zeolite.

Hereby, it is ensured that volatile vanadium and tungsten compounds are essentially adsorbed on the surface of titania and silica and that remaining amounts of NOx from upstream steps are selectively reduced to nitrogen and water by the SCR reaction.

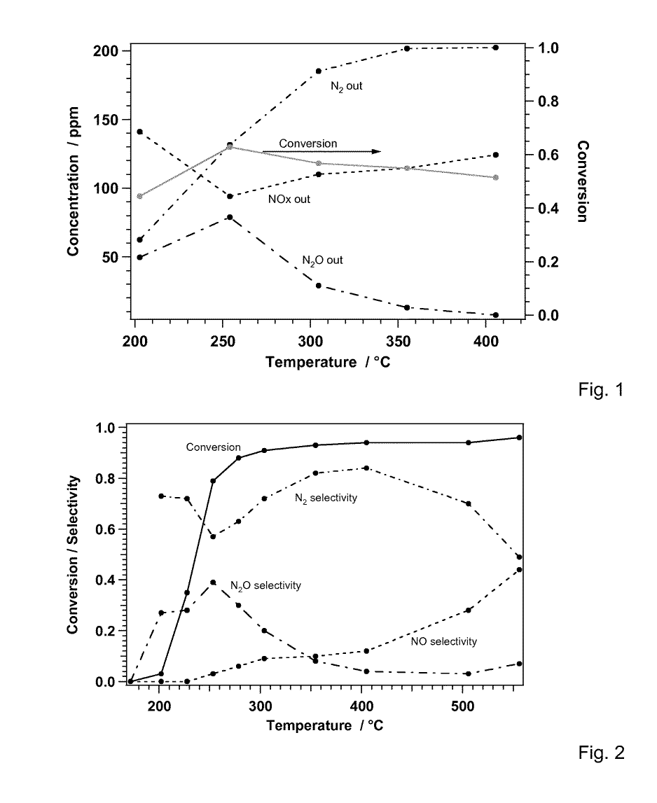

FIG. 1 displays the NOx conversion, together with the outlet concentrations of NOx, N₂O, and N₂. The performance under these conditions in NH₃-SCR is documented by a conversion of about 50-60% in the temperature range of interest (250-400° C.) with a low yield of N₂O and a high yield of N₂. FIG. 1 shows NOx conversion for NH3-SCR and outlet concentrations of NOx, N2, and N2O for a Pt/V—W-oxide based monolith three way catalyst, using a feed of 250 ppm NOx, 300 ppm NH3, 12% O2, and 4% water in nitrogen at a space velocity of 100000 h⁻¹.

FIG. 2 shows the conversion of ammonia, and selectivities to N2, NOx, N2O in the selective oxidation to ammonia. In the temperature range of interest (250-400□ C), the ammonia is almost completely converted and the reaction product consists mainly of nitrogen. FIG. 2 shows NH₃ conversion for selective oxidation of ammonia and selectivities to NOx, N₂, and N₂O for a Pt/V—W-oxide based monolith three way catalyst, using a feed of 200 ppm NH_{3, 12}% O₂, and 4% water in nitrogen at a space velocity of 100000 h⁻¹.

### EXAMPLE 1

This example demonstrates the performance in NH₃-SCR of a three way catalyst. The catalyst consists of Pt impregnated on a glass fiber paper based monolith that is reinforced with TiO₂, on top of which a washcoat layer, containing vanadium and tungsten, titanium dioxide and silica, having NH₃-SCR activity, is applied. The Pt content in the catalyst was 88 mg/l. The content of the SCR active washcoat layer was 197 g/l, of which 5% was silica. The catalyst was degreened at 550° C. for 1 hour prior to the performance test. The reactor feed gas consisted of 250 ppm NOx, of which less than 5% is present as NO₂, 300 ppm NH₃, 12% O₂, and 4% water in nitrogen. The flow rate was adjusted to reach a space velocity of 100000 h⁻¹, based on the monolith volume.

### EXAMPLE 2

This example shows the performance of the three way catalyst, as characterized in Example 1, for selective oxidation of ammonia to reduce ammonia slip. The catalyst was degreened for 1 h at 550□ C. The feed gas used in this measurement was 200 ppm NH3, 12% O2 and 4% water in nitrogen. The flow was adjusted to reach a space velocity of 100000 h-1 based on the monolith volume.

1. Three way catalyst having an NH3-SCR activity, an ammonia oxidation activity and an adsorption capacity for volatile vanadium and tungsten compounds volatilized off an upstream SCR active catalyst, the three way catalyst comprising high surface compounds selected from high surface metal oxides, zeolites, silica, non-zeolite silica alumina, and mixtures thereof.

2. The three way catalyst of claim 1, wherein the three way catalyst comprising a bottom layer comprising platinum, alumina and/or titania and optionally palladium coated on a substrate or partly or entirely forming the substrate and a top layer comprising oxides of vanadium, tungsten and titanium admixed with at least one of a high surface coria, alumina, silica, zirconia, non-zeolite silica alumina and zeolite.

3. The three way catalyst of claim 2, wherein the top layer has layer thickness of between 40 μm and 250 μm.

4. The three way catalyst of claim 2, wherein the bottom layer has a layer thickness of between 5 μm and 450 μm.

5. The three way catalyst of claim 2, wherein the top layer has a porosity of between 20% and 80%.

6. The three way catalyst according to claim 1, wherein the three way catalyst is coated on a substrate with a flow through monolith shape.

7. The three way catalyst according to claim 2, wherein the amount of the top layer in the three way catalyst is between 50 to 500 g per liter of the substrate.

8. The three way catalyst according to claim 2, wherein the amount of the bottom layer in the three way catalyst is between 5 and 255 g per liter of the substrate.

9. The three way catalyst according to claim 2, wherein the bottom layer of the three way catalyst contains 0.0018 g-0.35 g platinum and/or palladium per liter of the substrate.

10. The three way catalyst according to claim 2, wherein top layer of the three way, catalyst comprises per liter of the flow through monolith 1.0 g-20 g vanadium pentoxide, 3 g-40 g tungsten oxide, 40 g-460 g titania, and 0 g-86 g silica, 0-86 g ceria, 0 g-86 g alumina, 0 g-86 g non-zeolite silica alumina and 0 g-86 g of a zeolite.
